(19) United States
(12) Patent Application Publication
(10) Pub. No.: US 2017/0106589 A1
(43) Pub. Date: Apr. 20, 2017

(54) MANUFACTURING METHOD FOR THREE-DIMENSIONAL FORMED OBJECT AND MANUFACTURING APPARATUS FOR THREE-DIMENSIONAL FORMED OBJECT

(71) Applicant: SEIKO EPSON CORPORATION, Tokyo (JP)

(72) Inventors: Masaya ISHIDA, Hara-mura (JP); Takeshi MIYASHITA, Suwa (JP); Eiji OKAMOTO, Matsumoto (JP); Kentaro YAMADA, Matsumoto (JP)

(21) Appl. No.: 15/294,497

(22) Filed: Oct. 14, 2016

(30) Foreign Application Priority Data
Oct. 15, 2015 (JP) 2015-203459

(51) Int. Cl. B29C 67/00; B33Y 30/00; B33Y 50/02; B33Y 10/00

(52) U.S. Cl. CPC B29C 67/0059; B29C 67/0088; B29C 67/0092; B33Y 10/00; B33Y 30/00; B33Y 50/02; B29K 2505/00

(57) ABSTRACT

A manufacturing method for a three-dimensional formed object includes discharging a flowable composition including particles from a discharging section in a state of droplets and forming a layer. The forming the layer includes forming a contour layer corresponding to a contour of the three-dimensional formed object and forming an internal layer corresponding to an inside of the three-dimensional formed object in contact with the contour layer. At least a part of the droplets in the forming the contour layer is smaller than the droplets in the forming the internal layer.

### BACKGROUND

1. Technical Field

The present invention relates to a manufacturing method for a three-dimensional formed object and a manufacturing apparatus for a three-dimensional formed object.

2. Related Art

A manufacturing method for manufacturing a three-dimensional formed object by stacking layers has been carried out. As a kind of the manufacturing method, there has been disclosed a manufacturing method for manufacturing a three-dimensional formed object while forming layers using a flowable composition including particles.

For example, JP-A-2008-184622 (Patent Literature 1) discloses a manufacturing method for forming layers using metal paste and manufacturing a three-dimensional formed object while radiating a laser on a corresponding region of the three-dimensional formed object and sintering or melting the corresponding region.

However, in the manufacturing method for a three-dimensional formed object in the past, layers having one thickness are formed to manufacture the three-dimensional formed object. Therefore, when it is attempted to increase manufacturing speed, the thickness of the layers has to be increased to increase supply speed of the flowable composition including the particles of metal paste or the like (increase a supply amount per unit time). As a result, manufacturing accuracy decreases. On the other hand, when it is attempted to increase the manufacturing accuracy, the thickness of the layers has to be reduced to supply the flowable composition including the particles of metal paste or the like at high accuracy. As a result, the manufacturing speed decreases. In this way, in the manufacturing method for the three-dimensional formed object in the past, the manufacturing speed and the manufacturing accuracy are in a tradeoff relation.

### SUMMARY

An advantage of some aspects of the invention is to quickly manufacture a highly accurate three-dimensional formed object.

A first aspect of the invention is directed to a manufacturing method for a three-dimensional formed object including discharging a flowable composition including particles from a discharging section in a state of droplets and forming a layer. The forming the layer includes: forming a contour layer corresponding to a contour of the three-dimensional formed object; and forming an internal layer corresponding to an inside of the three-dimensional formed object in contact with the contour layer. At least a part of the droplets in the forming the contour layer is smaller than the droplets in the forming the internal layer.

According to this aspect, the contour layer is formed by the droplets smaller than the droplets in forming the internal layer. That is, the internal layer is formed by the relatively large droplets and the contour layer is formed by the relatively small droplets. Therefore, it is possible to quickly form the internal layer that does not need to be highly accurately formed in the three-dimensional formed object and it is possible to highly accurately form the contour layer that needs to be highly accurately formed in the three-dimensional formed object. Therefore, it is possible to quickly manufacture a highly accurate three-dimensional formed object.

A second aspect of the invention is directed to the manufacturing method for the three-dimensional formed object according to the first aspect, in which the forming the layer is executed using, as the discharging section, a first discharging section and a second discharging section that discharge the droplets having different sizes.

According to this aspect, it is possible to execute the layer formation using the first discharging section and the second discharging section that discharge the droplets having the different sizes. Therefore, it is possible to easily discharge the relatively large droplets and the relatively small droplets.

Note that the “discharge the droplets having different sizes” not only means that both of the first discharging section and the second discharging section are capable of discharging the droplets having one kind of sizes and the sizes of the respective droplets are different but also means that at least one of the first discharging section and the second discharging section is capable of discharging the droplets having a plurality of kinds of sizes and the sizes of the droplets dischargeable from the first discharging section and the second discharging section are partially the same.

A third aspect of the invention is directed to the manufacturing method for the three-dimensional formed object according to the first or second aspect, in which the manufacturing method for the three-dimensional formed object includes repeating the forming the layer in a stacking direction.

According to this aspect, the manufacturing method for the three-dimensional formed object includes the repeating the forming the layer in the stacking direction. Therefore, it is possible to easily manufacture the three-dimensional formed object by stacking layers.

A fourth aspect of the invention is directed to the manufacturing method for the three-dimensional formed object according to any one of the first to third aspects, in which the forming the layer includes binding the particles.

According to this aspect, the manufacturing method for the three-dimensional formed object includes the binding the particles. Therefore, it is possible to manufacture a robust three-dimensional formed object.

Note that examples of the “binding the particles” include sintering the particles and melting the particles.

A fifth aspect of the invention is directed to the manufacturing method for the three-dimensional formed object according to the fourth aspect, in which the forming the layer includes: executing the forming the contour layer a plurality of times to form a plurality the contour layers; executing the forming the internal layer to form the internal layer corresponding to thickness of the plurality of contour layers in a region corresponding to the plurality of contour layers; and executing the binding the particles to bind the particles corresponding to the plurality of contour layers.

According to this aspect, the forming the contour layer is executed a plurality of times to form a plurality of the contour layers and, then, the forming the internal layer is executed to form the internal layer corresponding to thickness of the plurality of contour layers in a region corresponding to the plurality of contour layers, and the particles corresponding to the plurality of contour layers are bound. That is, it is possible to reduce the number of times of the forming the internal layers. Therefore, it is possible to particularly quickly manufacture a highly accurate three-dimensional formed object.

The “contour” is a portion that forms a shape of the surface of the three-dimensional formed object. For example, when a coat layer is provided on the surface of the three-dimensional formed object, the “contour” sometimes means a lower layer of the coat layer.

A sixth aspect of the invention is directed to the manufacturing method for the three-dimensional formed object according to any one of the first to fifth aspects, in which the forming the layer includes discharging a flowable composition including same particles to the contour layer and the internal layer.

According to this aspect, the flowable composition including the same particles are discharged to the contour layer and the internal layer. Therefore, it is possible to manufacture the three-dimensional formed object with uniform components. It is possible to make use of material characteristics.

A seventh aspect of the invention is directed to the manufacturing method for the three-dimensional formed object according to any one of the first to sixth aspects, in which the forming the layer includes forming the internal layer having predetermined thickness without overlaying the droplets in the forming the internal layer and forming the contour layer having the predetermined thickness by overlaying a plurality of the droplets in the forming the contour layer.

According to this aspect, the forming the layer includes forming the internal layer having predetermined thickness without overlaying the droplets in the forming the internal layer and forming the contour layer having the predetermined thickness by overlaying a plurality of the droplets in the forming the contour layer. That is, layer thickness equivalent to a plurality of the contour layers corresponds to the layer thickness of one internal layer. Therefore, it is unnecessary to perform, for example, adjustment of layer thicknesses involved in the difference between the layer thicknesses of the contour layer and the internal layer. It is possible to easily manufacture a highly accurate three-dimensional formed object.

Note that the “forming the contour layer having the predetermined thickness by overlaying a plurality of the droplets in the forming the contour layer” not only means that the plurality of droplets are overlaid to form the contour layer having the predetermined thickness in the forming the contour layer once but also means that the plurality of droplets are overlaid to form the contour layer having the predetermined thickness in the forming the contour layer a plurality of times.

An eighth aspect of the invention is directed to the manufacturing method for the three-dimensional formed object according to any one of the first to seventh aspects, in which the particles contain at least one of magnesium, iron, copper, cobalt, titanium, chrome, nickel, aluminum, maraging steel, stainless steel, cobalt chrome molybdenum, a titanium alloy, a nickel alloy, an aluminum alloy, a cobalt alloy, a cobalt chrome alloy, alumina, silica, polyamide, polyacetal, polycarbonate, modified polyphenylene ether, polybutylene terephthalate, polyethylene terephthalate, polysulphone, polyether sulphone, polyphenylene sulfide, polyallylate, polyimide, polyamide imide, polyether imide, and polyether etherketone.

According to this aspect, the particles are metal, an alloy, ceramics, or thermoplastic resin. Therefore, it is possible to manufacture highly accurate various three-dimensional formed objects by performing binding of the particles.

A ninth aspect of the invention is directed to a manufacturing apparatus for a three-dimensional formed object including: a discharging section configured to discharge, in a state of droplets, a flowable composition including particles; and a control section configured to control the discharging section to discharge the droplets to form layers. The control section performs control to form a contour layer corresponding to a contour of the three-dimensional formed object and an internal layer corresponding to an inside of the three-dimensional formed object in contact with the contour layer such that the droplets in forming the contour layer are smaller than at least a part of the droplets in forming the internal layer.

According to this aspect, the contour layer is formed by the droplets smaller than the droplets in forming the internal layer. That is, the internal layer is formed by the relatively large droplets and the contour layer is formed by the relatively small droplets. Therefore, it is possible to quickly form the internal layer that does not need to be highly accurately formed in the three-dimensional formed object and it is possible to highly accurately form the contour layer that needs to be highly accurately formed in the three-dimensional formed object. Therefore, it is possible to quickly manufacture a highly accurate three-dimensional formed object.

### BRIEF DESCRIPTION OF THE DRAWINGS

The invention will be described with reference to the accompanying drawings, wherein like numbers reference like elements.

FIG. 1A is a schematic configuration diagram showing the structure of a manufacturing apparatus for a three-dimensional formed object according to an embodiment of the invention.

FIG. 1B is an enlarged view of a B part shown in FIG. 1A.

FIG. 2A is a schematic configuration diagram showing the configuration of the manufacturing apparatus for the three-dimensional formed object according to the embodiment of the invention.

FIG. 2B is an enlarged view of a B′ part shown in FIG. 2A.

FIG. 3A is a schematic configuration diagram showing the configuration of the manufacturing apparatus for the three-dimensional formed object according to the embodiment of the invention.

FIG. 3B is an enlarged view of a C part shown in FIG. 3A.

FIG. 4A is a schematic configuration diagram showing the configuration of the manufacturing apparatus for the three-dimensional formed object according to the embodiment of the invention.

FIG. 4B is an enlarged view of a C′ part shown in FIG. 4A.

FIG. 5 is a schematic perspective view of a head base according to the embodiment of the invention.

FIGS. 6A to 6C are plan views for conceptually explaining a relation between the disposition of head units and a formation form of a molten section according to the embodiment of the invention.

FIGS. 7A and 7B are schematic diagrams for conceptually explaining the formation form of the molten section.

FIGS. 8A and 8B are schematic diagrams showing examples of other kinds of disposition of the head unit disposed in the head base.

FIGS. 9A to 9N are schematic diagrams showing a manufacturing process for a three-dimensional formed object according to the embodiment of the invention.

FIG. 10 is a flowchart of a manufacturing method for a three-dimensional formed object according to the embodiment of the invention.

### DESCRIPTION OF EXEMPLARY EMBODIMENTS

An embodiment of the invention is explained below with reference to the drawings.

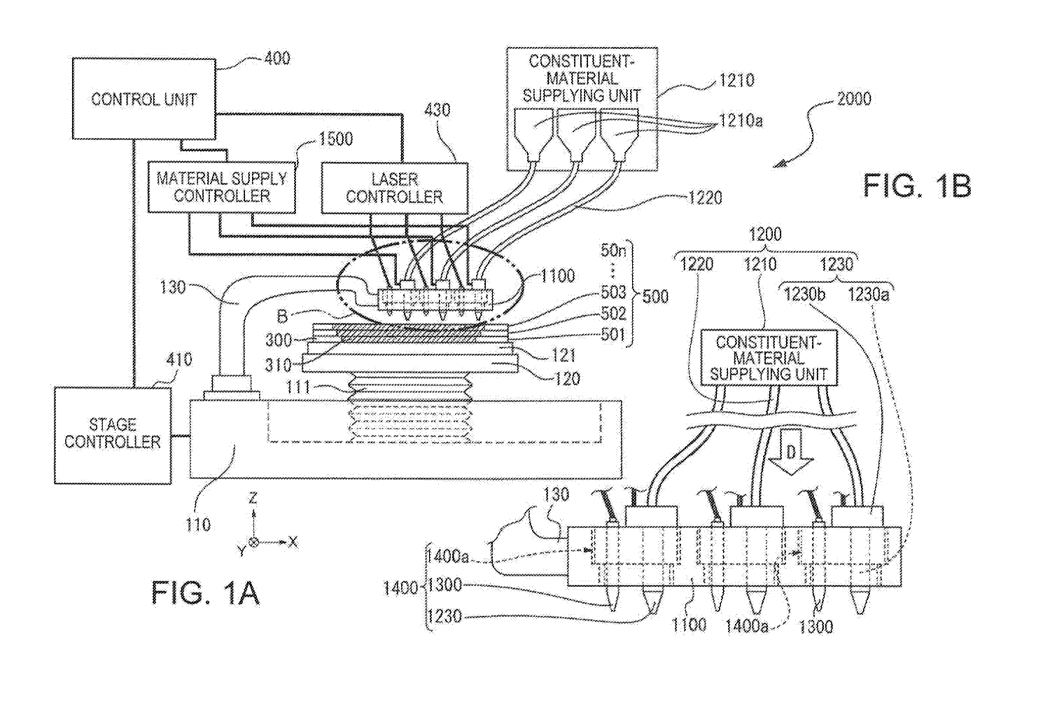

FIGS. 1A to 4B are schematic configuration diagrams showing the configurations of a manufacturing apparatus for a three-dimensional formed object according to an embodiment of the invention.

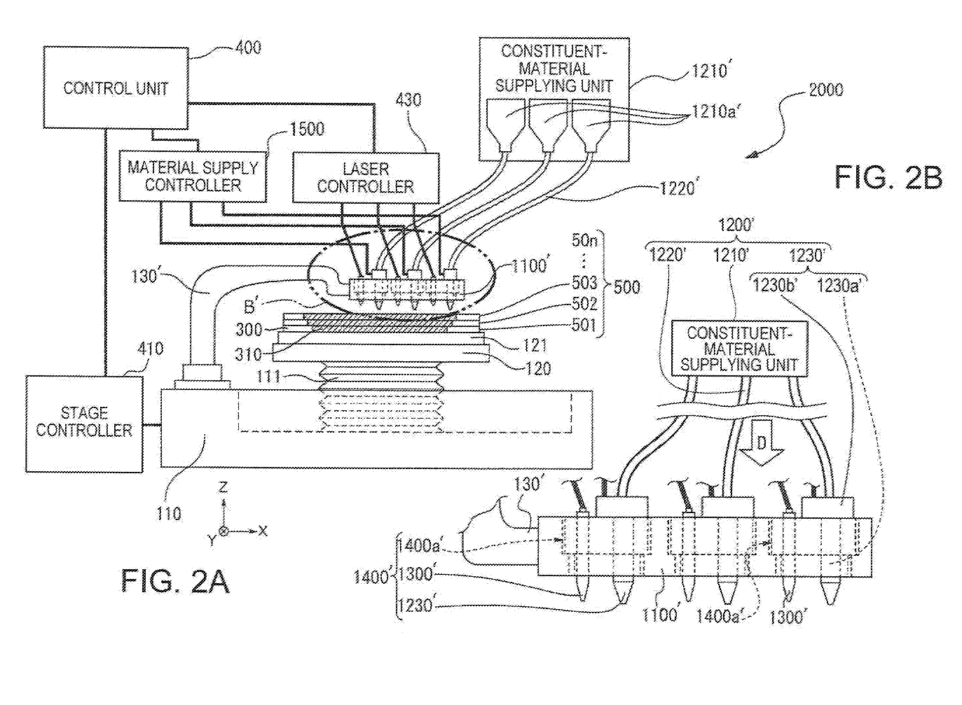

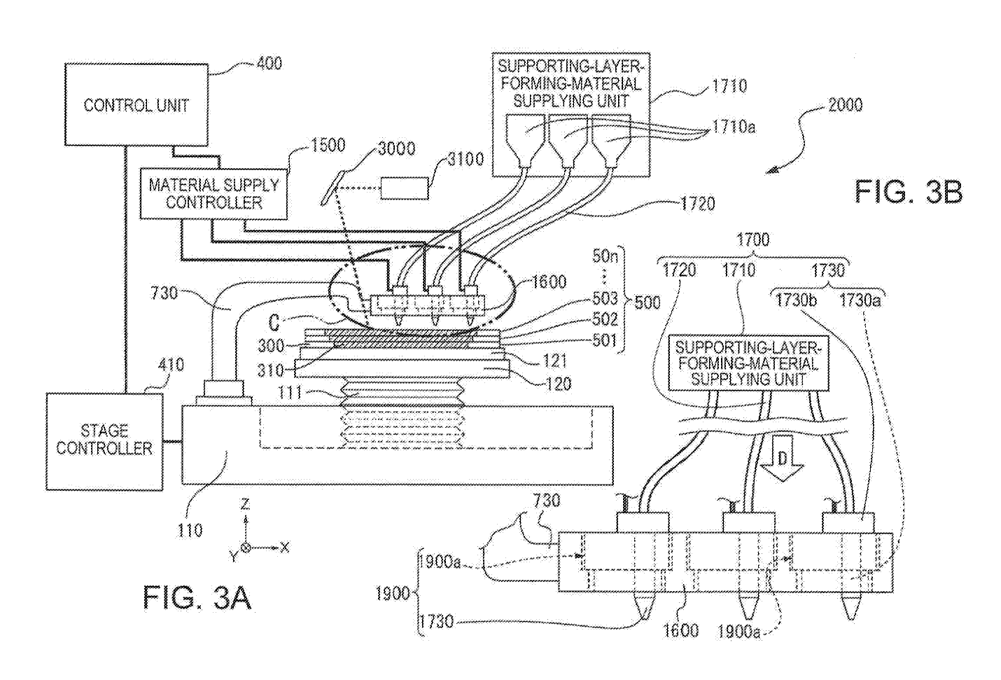

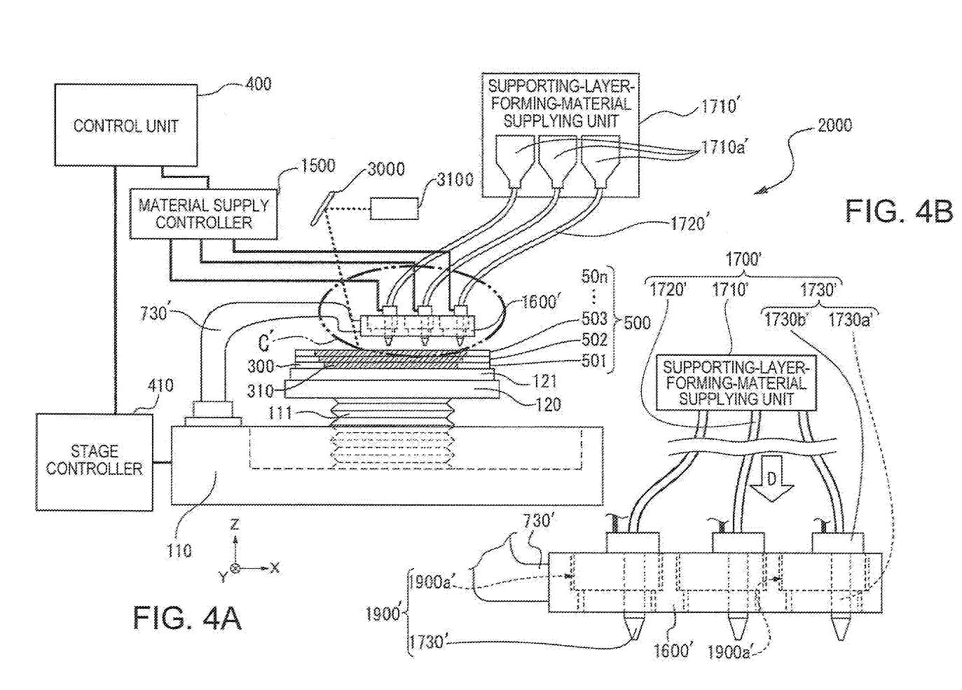

The manufacturing apparatus for the three-dimensional formed object in this embodiment includes four kinds of material supplying sections (head bases). However, FIGS. 1A to 4B are diagrams each showing only one material supplying section. The other material supplying sections are omitted. The material supplying sections shown in FIGS. 1A and 1B and FIG. 2A and 2B are material supplying sections that supply a constituent material of the three-dimensional formed object. The material supplying sections include laser radiating sections for solidifying (melting) the constituent material. The material supplying sections shown in FIGS. 3A and 3B and FIGS. 4A and 4B are material supplying sections that supply a material for supporting layer formation for forming a supporting layer that supports the constituent material when the three-dimensional formed object is formed.

Note that “three-dimensional forming” in this specification indicates formation of a so-called solid formed object. The “three-dimensional forming” also includes formation of a shape having thickness even if the shape is, for example, a flat shape, a so-called two-dimensional shape. “Support” means, besides support from a lower side, support from a lateral side and means support from an upper side in some case.

A manufacturing apparatus 2000 for a three-dimensional formed object (hereinafter referred to as forming apparatus 2000) shown in FIGS. 1A to 4B includes a base 110 and a stage 120 provided to be capable of being driven to move in X, Y, and Z directions shown in the figures or rotate in a rotating direction centering on a Z axis by a driving device 111 functioning as driving means included in the base 110.

As shown in FIGS. 1A and 1B, the forming apparatus 2000 includes a head-base supporting section 130, one end portion of which is fixed to the base 110 and at the other end portion of which a head base 1100, which holds a plurality of head units 1400 including constituent-material discharging sections 1230 that discharge a constituent material of a three-dimensional formed object and energy radiating sections 1300, is held and fixed.

As shown in FIGS. 2A and 2B, the forming apparatus 2000 includes a head-base supporting section 130′, one end portion of which is fixed to the base 110 and at the other end portion of which a head base 1100′, which holds a plurality of head units 1400′ including constituent-material discharging sections 1230′ that discharge constituent material of a three-dimensional formed object and energy radiating sections 1300′, is held and fixed.

As shown in FIGS. 3A and 3B, the forming apparatus 2000 includes a head-base supporting section 730, one end portion of which is fixed to the base 110 and at the other end portion of which a head base 1600, which holds a plurality of head units 1900 including supporting-layer-forming-material discharging sections 1730 that discharge a supporting layer forming material for supporting a three-dimensional formed object, is held and fixed.

Further, as shown in FIGS. 4A and 4B, the forming apparatus 2000 includes a head-base supporting section 730′, one end portion of which is fixed to the base 110 and at the other end portion of which a head base 1600′, which holds a plurality of head units 1900′ including supporting-layer-forming-material discharging sections 1730′ that discharge a supporting layer forming material for supporting a three-dimensional formed object, is held and fixed.

The head base 1100, the head base 1100′, the head base 1600, and the head base 1600′ are provided in parallel on an XY plane.

Note that the constituent-material discharging sections 1230 and the constituent-material discharging sections 1230′ are configured the same and the supporting-layer-forming-material discharging sections 1730 and the supporting-layer-forming-material discharging section 1730′ are configured the same except that the seizes (dot diameters) of droplets are different. The constituent-material discharging sections 1230 and the supporting-layer-forming-material discharging sections 1730 are configured the same and the constituent-material discharging sections 1230′ and the supporting-layer-forming-material discharging section 1730′ are configured the same except that materials to be discharged (constituent materials and supporting layer forming materials) are different. The energy radiating sections 1300 and the energy radiating sections 1300′ are configured the same. However, the forming apparatus 2000 is not limited to such a configuration.

On the stage 120, layers 501, 502, and 503 in a formation process of a three-dimensional formed object 500 are formed. Note that, as explained in detail below, it is possible to form layers having different thicknesses by discharging droplets having different dot diameters from the constituent-material discharging sections 1230, the constituent-material discharging sections 1230′, the supporting-layer-forming-material discharging sections 1730, and the supporting-layer-forming-material discharging section 1730′. It is possible to discharge droplets having a relatively small dot diameter to form a thin layer using the constituent-material discharging sections 1230 and the supporting-layer-forming-material discharging sections 1730. It is possible to discharge droplets having a relatively large dot diameter and form a thick layer using the constituent-material discharging sections 1230′ and the supporting-layer-forming-material discharging section 1730′.

For the formation of the three-dimensional formed object 500, heat is generated by radiation of the laser. Therefore, the three-dimensional formed object 500 may be formed on a sample plate 121 using the sample plate 121 having heat resistance. Consequently, it is possible to protect the stage 120 from heat generated by the radiation of the laser. By using, for example, a ceramic plate as the sample plate 121, it is possible to obtain high heat resistance. Further, the ceramic plate has low responsiveness to a constituent material of a three-dimensional formed object to be melted (or sintered) . It is possible to prevent degeneration of the three-dimensional formed object 500. Note that, in FIGS. 1A, 2A, 3A, and 4A, for convenience of explanation, three layers of the layers 501, 502, and 503 are illustrated. However, layers are stacked up to a desired shape of the three-dimensional formed object 500 (a layer 50n shown in FIGS. 1A, 2A, 3A, and 4A) .

The layers 501, 502, 503, . . . , and 50n are respectively configured by supporting layers 300 formed by the supporting layer forming material discharged from the supporting-layer-forming-material discharging sections 1730 and 1730′ and molten layers 310 formed by the constituent material discharged from the constituent-material discharging sections 1230 and 1230′ and melted by the energy radiating sections 1300 and 1300′.

FIG. 1B is a B-part enlarged conceptual diagram showing the head base 1100 shown in FIG. 1A. As shown in FIG. 1B, the plurality of head units 1400 are held in the head base 1100. As explained in detail below, one head unit 1400 is configured by holding, with a holding jig 1400a, the constituent-material discharging section 1230 included in the constituent-material supplying device 1200 and the energy radiating section 1300. The constituent-material discharging section 1230 includes a discharge nozzle 1230a and a discharge driving section 1230b caused by a material supply controller 1500 to discharge the constituent material from the discharge nozzle 1230a.

FIG. 2B is a B′-part enlarged conceptual diagram showing the head base 1100′ shown in FIG. 2A. As shown in FIG. 2B, the plurality of head units 1400′ are held in the head base 1100′. One head unit 1400′ is configured by holding, with a holding jig 1400a′, the constituent-material discharging section 1230′ included in the constituent-material supplying device 1200′ and the energy radiating section 1300′. The constituent-material discharging section 1230′ includes a discharge nozzle 1230a′ and a discharge driving section 1230b′ caused by the material supply controller 1500 to discharge the constituent material from the discharge nozzle 1230a′. Note that the head base 1100′ has a configuration same as the configuration of the head base 1100 except that a dot diameter of droplets discharged from the constituent-material discharging section 1230′ is different from a dot diameter of droplets discharged from the constituent-material discharging section 1230.

FIG. 3B is a C-part enlarged conceptual diagram showing the head base 1600 shown in FIG. 3A. As shown in FIG. 3B, the plurality of head units 1900 are held in the head base 1600. One head unit 1900 is configured by holding, with a holding jig 1900a, the supporting-layer-forming-material discharging section 1730 included in the supporting-layer-forming-material supplying device 1700. The supporting-layer-forming-material discharging section 1730 includes a discharge nozzle 1730a and a discharge driving section 1730b caused by the material supply controller 1500 to discharge the supporting layer forming material from the discharge nozzle 1730a. The forming apparatus 2000 includes, above the stage 120, a laser radiating section 3100 for sintering the supporting layer forming material and a galvanometer mirror 3000 that positions a laser beam radiated from the laser radiating section 3100.

FIG. 4B is a C′-part enlarged conceptual diagram showing the head base 1600′ shown in FIG. 4A. As shown in FIG. 4B, the plurality of head units 1900′ are held in the head base 1600′. One head unit 1900′ is configured by holding, with a holding jig 1900a′, the supporting-layer-forming-material discharging section 1730′ included in the supporting-layer-forming-material supplying device 1700′. The supporting-layer-forming-material discharging section 1730′ includes a discharge nozzle 1730a′ and a discharge driving section 1730b′ caused by the material supply controller 1500 to discharge the supporting layer forming material from the discharge nozzle 1730a′. Note that the head base 1600′ has a configuration same as the configuration of the head base 1600 except that a dot diameter of droplets discharged from the supporting-layer-forming-material discharging section 1730′ is different from a dot diameter of droplets discharged from the supporting-layer-forming-material discharging section 1730.

Note that the forming apparatus 2000 according to this embodiment includes the constituent-material discharging sections 1230 and 1230′ that discharge droplets having different dot diameters and the supporting-layer-forming-material discharging sections 1730 and 1730′ that discharge droplets having different dot diameters. However, the forming apparatus 2000 is not limited to such a configuration and may have, for example, a configuration in which the constituent-material discharging sections 1230 and the supporting-layer-forming-material discharging sections 1730 are capable of respectively discharging droplets having different dot diameters (capable of forming layers having different layer thicknesses (thicknesses) and the head bases 1100′ and 1600′ are omitted.

In this embodiment, the energy radiating sections 1300 and 1300′ are explained as energy radiating sections that radiate a laser, which is an electromagnetic wave, as energy (in the following explanation, the energy radiating sections 1300 and 1300′ are referred to as laser radiating sections 1300 and 1300′). By using the laser as the energy to be radiated, it is possible to radiate the energy targeting a supply material set as a target. It is possible to form a high-quality three-dimensional formed object. It is possible to easily control a radiated energy amount (power and scanning speed) according to, for example, a type of a material to be discharged. It is possible to obtain a three-dimensional formed object having desired quality. However, the forming apparatus 2000 is not limited to such a configuration. A configuration may be adopted in which energy applying sections that apply heat generated by arc discharge are provided instead of the laser radiating sections 1300 and 1300′ and the layers 501, 502, 503, . . . , and 50n are solidified by being sintered or melted with the heat generated by the arc discharge. Note that, it goes without saying that it is also possible to select to sinter and solidify or melt and solidify the material to be discharged. That is, depending on a case, the material to be discharged is a sintered material, a melted material, or a solidified material solidified by another method.

As shown in FIGS. 1A and 1B, the constituent-material discharging sections 1230 are connected to, by supply tubes 1220, a constituent-material supplying unit 1210 that stores constituent materials associated with the respective head units 1400 held in the head base 1100. Predetermined constituent materials are supplied from the constituent-material supplying unit 1210 to the constituent-material discharging sections 1230. In the constituent-material supplying unit 1210, materials (paste-like constituent materials including metal particles) including raw materials of the three-dimensional formed object 500 formed by the forming apparatus 2000 according to this embodiment are stored in constituent-material storing sections 1210a as supply materials. The respective constituent-material storing sections 1210a are connected to the respective constituent-material discharging sections 1230 by the supply tubes 1220. Since the constituent-material supplying unit 1210 includes the respective constituent-material storing sections 1210a in this way, it is possible to supply a plurality of different kinds of materials from the head base 1100.

As shown in FIGS. 2A and 2B, the constituent-material discharging sections 1230′ are connected to, by supply tubes 1220′, a constituent-material supplying unit 1210′ that stores constituent materials associated with the respective head units 1400′ held in the head base 1100′. Predetermined constituent materials are supplied from the constituent-material supplying unit 1210′ to the constituent-material discharging sections 1230′. In the constituent-material supplying unit 1210′, materials (paste-like constituent materials including metal particles) including raw materials of the three-dimensional formed object 500 formed by the forming apparatus 2000 according to this embodiment are stored in constituent-material storing sections 1210a′ as supply materials. The respective constituent-material storing sections 1210a′ are connected to the respective constituent-material discharging sections 1230′ by the supply tubes 1220′. Since the constituent-material supplying unit 1210′ includes the respective constituent-material storing sections 1210a′ in this way, it is possible to supply a plurality of different kinds of materials from the head base 1100′.

As shown in FIGS. 3A and 3B, the supporting-layer-forming-material discharging sections 1730 are connected to, by supply tubes 1720, supporting-layer-forming-material supplying units 1710 that store supporting layer forming materials associated with the respective head units 1900 held in the head base 1600. Predetermined supporting layer forming materials are supplied from the supporting-layer-forming-material supplying units 1710 to the supporting-layer-forming-material discharging sections 1730. In the supporting-layer-forming-material supplying units 1710, supporting layer forming materials (paste-like supporting layer forming materials including ceramics particles) forming a supporting layer in forming the three-dimensional formed object 500 are stored in supporting-layer-forming-material storing sections 1710a as supply materials. The respective supporting-layer-forming-material storing sections 1710a are connected to the respective supporting-layer-forming-material discharging sections 1730 by the supply tubes 1720. Since the supporting-layer-forming-material supplying units 1710 include the respective supporting-layer-forming-material storing sections 1710a in this way, it is possible to supply a plurality of different kinds of supporting layer forming materials from the head base 1600.

As shown in FIGS. 4A and 4B, the supporting-layer-forming-material discharging sections 1730′ are connected to, by supply tubes 1720′, supporting-layer-forming-material supplying units 1710′ that store supporting layer forming materials associated with the respective head units 1900′ held in the head base 1600′. Predetermined supporting layer forming materials are supplied from the supporting-layer-forming-material supplying units 1710′ to the supporting-layer-forming-material discharging sections 1730′. In the supporting-layer-forming-material supplying units 1710′, supporting layer forming materials (paste-like supporting layer forming materials including ceramics particles) forming a supporting layer in forming the three-dimensional formed object 500 are stored in supporting-layer-forming-material storing sections 1710a′ as supply materials. The respective supporting-layer-forming-material storing sections 1710a′ are connected to the respective supporting-layer-forming-material discharging sections 1730′ by the supply tubes 1720′. Since the supporting-layer-forming-material supplying units 1710′ include the respective supporting-layer-forming-material storing sections 1710a′ in this way, it is possible to supply a plurality of different kinds of supporting layer forming materials from the head base 1600′.

The constituent material supplied as the melted material or the sintered material contains metal serving as a raw material of the three-dimensional formed object 500. As the constituent material, it is possible to use, for example, powder of magnesium (Mg) , iron (Fe) , cobalt (Co) , chrome (Cr), aluminum (Al), titanium (Ti), nickel (Ni), or copper (Cu) or a slurry-like (or paste-like) material including powder of an alloy containing one or more of these kinds of metal (maraging steel, stainless steel, cobalt chrome molybdenum, a titanium alloy, a nickel alloy, an aluminum alloy, a cobalt alloy, or a cobalt chrome alloy) , alumina, silica, or the like, a solvent, and a binder.

It is possible to use general-purpose engineering plastic such as polyamide, polyacetal, polycarbonate, modified polyphenylene ether, polybutylene terephthalate, or polyethylene terephthalate. Besides, it is possible to use engineering plastic such as polysulphone, polyether sulphone, polyphenylene sulfide, polyallylate, polyimide, polyamide imide, polyether imide, or polyether etherketone.

Expressed in another way, the constituent material in this embodiment is a flowable composition including metal particles. However, particles are not particularly limited. It is possible to use particles of the general-purpose engineering plastic and the engineering plastic other than metal particles and alloy particles.

The supporting layer forming material contains ceramics. As the supporting layer forming material, for example, it is possible to use, for example, a slurry-like (or paste-like) mixed material containing mixed powder of metal oxide, metal, and the like, a solvent, and a binder.

Expressed in another way, the supporting layer forming material in this embodiment is a flowable composition including ceramic particles. However, particles are not particularly limited. It is possible to use particles other than the ceramic particles.

The forming apparatus 2000 includes a control unit 400 functioning as control means for controlling, on the basis of data for forming of a three-dimensional formed object output from a not-shown data output apparatus such as a personal computer, the stage 120, the constituent-material discharging sections 1230 and 1230′ and the laser radiating sections 1300 and 1300′ included in the constituent-material supplying devices 1200 and 1200′ and the supporting-layer-forming-material discharging sections 1730 and 1730′ included in the supporting-layer-forming-material supplying devices 1700 and 1700′. The control unit 400 includes, although not shown in the figures, a control section that controls the stage 120, the constituent-material discharging sections 1230 and the laser radiating sections 1300, and the constituent-material discharging section 1230′ and the laser radiating sections 1300′ to be driven and operate in association with one another and controls the stage 120 and the supporting-layer-forming-material discharging sections 1730 and 1730′ to be driven and operate in association with each other.

For the stage 120 movably provided on the base 110, signals for controlling a movement start, a stop, a moving direction, a moving amount, moving speed, and the like of the stage 120 are generated in a stage controller 410 on the basis of a control signal from the control unit 400. The signals are sent to the driving device 111 included in the base 110. The stage 120 moves in the X, Y, and Z directions shown in the figures. For the constituent-material discharging sections 1230 and 1230′ included in the head units 1400 and 1400′, signals for controlling material discharge amounts and the like from the discharge nozzles 1230a and 1230a′ in the discharge driving sections 1230b and 1230b′ included in the constituent-material discharging sections 1230 and 1230′ are generated in the material supply controller 1500 on the basis of a control signal from the control unit 400. Predetermined amounts of constituent materials are discharged from the discharge nozzles 1230a and 1230a′ according to the generated signals.

Similarly, for the supporting-layer-forming-material discharging sections 1730 and 1730′ included in the head units 1900 and 1900′, signals for controlling material discharge amounts and the like from the discharge nozzles 1730a and 1730a′ in the discharge driving sections 1730b and 1730b′ included in the supporting-layer-forming-material discharging sections 1730 and 1730′ are generated in the material supply controller 1500 on the basis of a control signal from the control unit 400. Predetermined amounts of supporting layer forming materials are discharged from the discharge nozzles 1730a and 1730a′ according to the generated signals.

For the laser radiating sections 1300 and 1300′, a control signal from the control unit 400 is sent to the laser controller 430. An output signal for causing any ones or all of the pluralities of laser radiating sections 1300 and 1300′ to radiate a laser is sent from the laser controller 430.

The laser radiation from the laser radiating sections 1300 and 1300′ is controlled such that the laser is radiated on desired regions of the layers 501, 502, 503, . . . , and 50n in synchronization with a driving signal for the stage 120 by the stage controller 410.

The head unit 1400 is explained more in detail. Note that the head unit 1400′ has a configuration same as the configuration of the head unit 1400. The head units 1900 and 1900′ have a configuration same as the configuration of the head unit 1400 except that the laser radiating section 1300 is not provided the supporting-layer-forming-material discharging sections 1730 and 1730′ are configured in the same disposition instead of the constituent-material discharging section 1230. Therefore, detailed explanation of the configuration concerning the head units 1400′, 1900, and 1900′ is omitted.

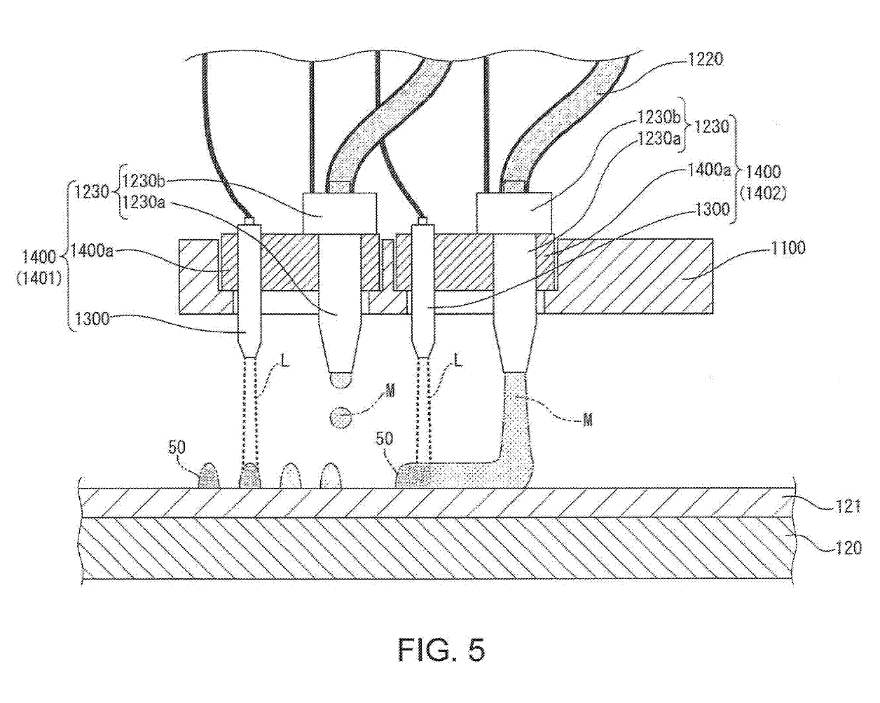

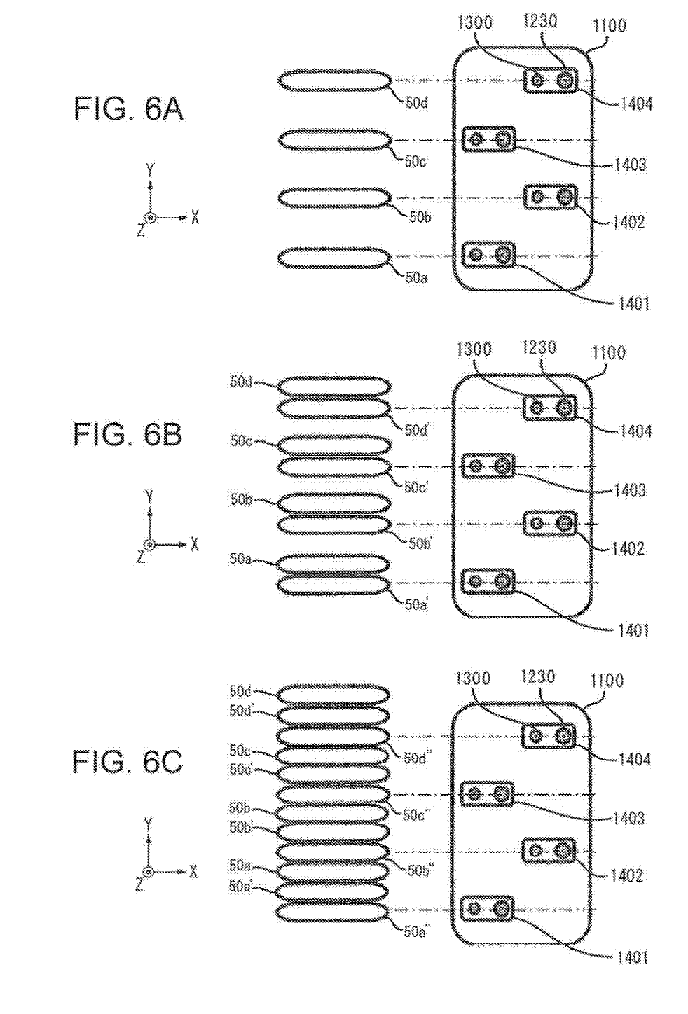

FIGS. 5 and 6A to 6C show an example of a holding form of the plurality of head units 1400 held in the head base 1100 and the laser radiating sections 1300 and the constituent-material discharging sections 1230 held by the head units 1400. FIGS. 6A to 6C are exterior views of the head base 1100 from an arrow D direction shown in FIG. 1B.

Note that the following explanation is an example in which desired regions of the layers 501, 502, 503, . . . , and 50n are melted and solidified. However, the desired regions may be sintered and solidified at temperature lower than temperature for melting and solidifying the desired regions.

As shown in FIG. 5, the plurality of head units 1400 are held in the head base 1100 by not-shown fixing means. As shown in FIGS. 6A to 6C, the head base 1100 of the forming apparatus 2000 according to this embodiment, includes the head units 1400 in which four units, that is, a head unit 1401 in a first row, a head unit 1402 in a second row, a head unit 1403 in a third row, and a head unit 1404 in a fourth row are disposed in a zigzag. As shown in FIG. 6A, the constituent materials are discharged from the head units 1400 while moving the stage 120 in the X direction with respect to the head base 1100. Lasers L are radiated from the laser radiating sections 1300 to form molten sections 50 (molten sections 50a, 50b, 50c, and 50d). A formation procedure for the molten sections 50 is explained below.

Note that, although not shown in the figure, the constituent-material discharging sections 1230 included in the respective head units 1401 to 1404 are connected to the constituent-material supplying unit 1210 by the supply tubes 1220 via the discharge driving sections 1230b. The laser radiating sections 1300 are connected to the laser controller 430 and held by the holding jigs 1400a.

As shown in FIG. 5, a material M, which is a constituent material of a three-dimensional formed object, is discharged from the discharge nozzles 1230a of the constituent-material discharging sections 1230 onto the sample plate 121 placed on the stage 120. In the head unit 1401, a discharge form in which the material M is discharged in a droplet state is illustrated. In the head unit 1402, a discharge form in which the material M is supplied in a continuous body state is illustrated. The discharge form of the material M in the forming apparatus 2000 according to this embodiment is the droplet state. However, the forming apparatus 2000 in which a part of the discharge nozzles 1230a is capable of supplying the constituent material in the continuous body state can also be used.

The material M discharged from the discharge nozzle 1230a in the droplet state flies substantially in the gravity direction and arrives on the sample plate 121. The laser radiating section 1300 is held by the holding jig 1400a. When the material M arriving on the sample plate 121 enters a laser radiation range according to the movement of the stage 120, the material M melts. Outside the laser radiation range, the material M solidifies and the molten sections 50 are formed. An aggregate of the molten sections 50 is formed as the molten layer 310 (see FIG. 1A) of the three-dimensional formed object 500 formed on the sample plate 121.

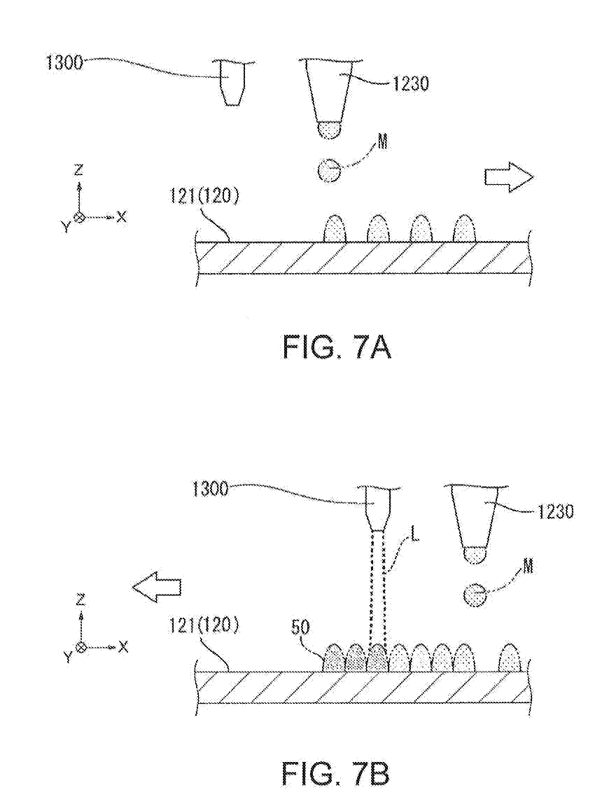

A formation procedure for the molten sections 50 is explained with reference to FIGS. 6A to 7B.

FIGS. 6A to 6C are plan views for conceptually explaining a relation between the disposition of the head units 1400 and a formation form of the molten sections 50 in this embodiment. FIGS. 7A and 7B are side views for conceptually showing the formation form of the molten sections 50.

First, when the stage 120 moves in a +X direction, the material M is discharged from the plurality of discharge nozzles 1230a in the droplet state. The material M is disposed in predetermined positions of the sample plate 121. When the stage 120 further moves in the +X direction, the material M enters the radiation range of the laser L radiated from the laser radiating section 1300 and melts. When the stage 120 further moves in the +X direction, the material M exits the radiation range of the laser L and solidifies and the molten sections 50 are formed.

More specifically, first, as shown in FIG. 7A, the material M is disposed in the predetermined positions of the sample plate 121 at fixed intervals from the plurality of discharge nozzles 1230a while moving the stage 120 in the +X direction.

Subsequently, as shown in FIG. 7B, while moving the stage 120 in a −X direction shown in FIG. 1A, the material M is disposed anew to fill spaces among the predetermined positions where the material M is disposed at the fixed intervals. When the stage 120 is continuously moved in the −X direction, the material M enters the radiation range of the laser L and is melted (the molten sections 50 are formed).

Note that time from the disposition of the material M in the predetermined positions until the material M enters the radiation range of the laser L can be adjusted according to moving speed of the stage 120. For example, when a solvent is included in the material M, it is possible to facilitate drying of the solvent by reducing the moving speed of the stage 120 and increasing the time until the material M enters the radiation range.

A configuration may be adopted in which, while moving the stage 120 in the +X direction, the material M is disposed to overlap (not to be spaced apart) in the predetermined positions of the sample plate 121 from the plurality of discharge nozzles 1230a and enters the radiation range of the laser L while being kept moving in the same direction (the molten sections 50 are formed by only movement on one side in the X direction of the stage 120 rather than forming the molten sections 50 by reciprocating movement in the X direction of the stage 120) .

By forming the molten sections 50 as explained above, the molten sections 50 (the molten sections 50a, 50b, 50c, and 50d) for one line in the X direction (first line in a Y direction) of the head units 1401, 1402, 1403, and 1404 shown in FIG. 6A are formed.

Subsequently, in order to form the molten sections 50 (the molten sections 50a, 50b, and 50c) in a second line in the Y direction of the head units 1401, 1402, 1403, and 1404, the head base 1100 is moved in a −Y direction. As a moving amount, when a pitch between the nozzles is represented as P, the head base 1100 is moved in the −Y direction by P/n (n is a natural number) pitch. In this embodiment, n is assumed to be 3.

By performing operation same as the operation explained above as shown in FIGS. 7A and 7B, molten sections 50′ (molten sections 50a′, 50b′, 50c′, and 50d′) in the second line in the Y direction shown in FIG. 6B are formed.

Subsequently, in order to form the molten sections 50 (the molten sections 50a, 50b, 50c, and 50d) in a third line in the Y direction of the head units 1401, 1402, 1403, and 1404, the head base 1100 is moved in the −Y direction. As a moving amount, the head base 1100 is moved in the −Y direction by P/3 pitch.

By performing operation same as the operation explained above as shown in FIGS. 7A and 7B, molten sections 50″ (molten sections 50a ″, 50b ″, 50c ″, and 50d ″) in the third line in the Y direction shown in FIG. 6C are formed. The molten layer 310 can be obtained.

Note that the supporting layer 300 can be formed by the same method except that the supporting layer forming material is discharged from the supporting-layer-forming-material discharging section 1730 before or after the molten layer 310 is formed as explained above in the layer 501 in the first layer and the discharged material is not melted. The supporting layer 300 is desirably in a sintered state. When the layers 502, 503, . . . , and 50n are formed to be stacked on the layer 501, the molten layers 310 and the supporting layers 300 can be formed in the same manner.

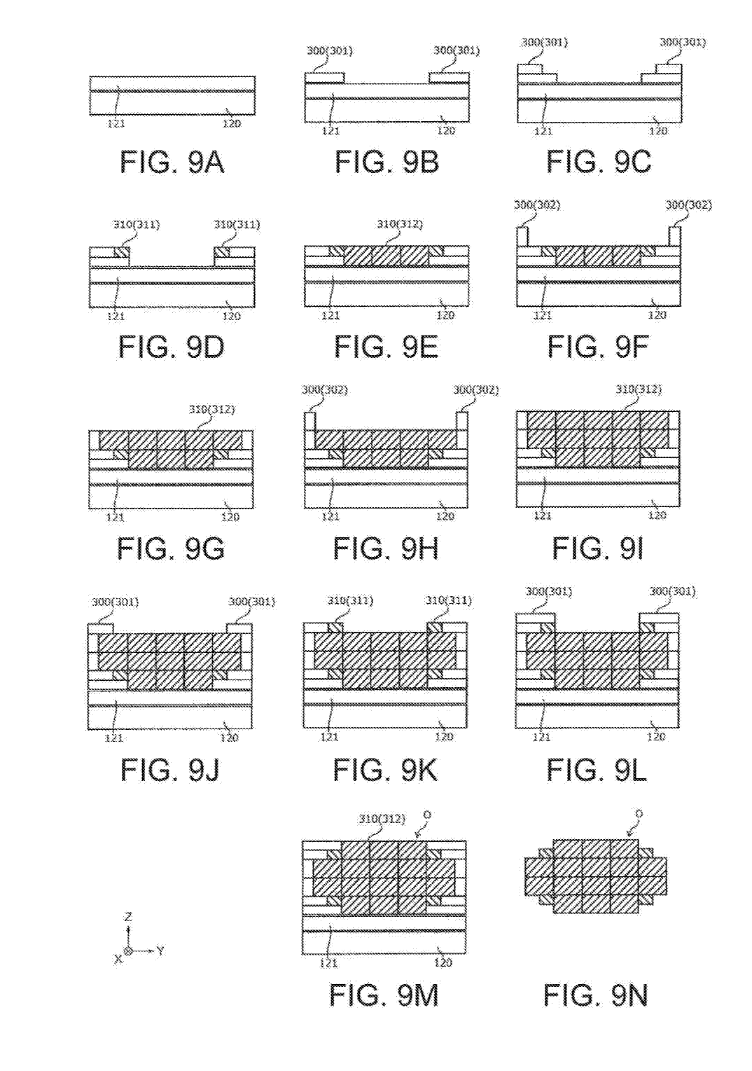

Discharge of the constituent material from the constituent-material discharging sections 1230′, melting by radiation of the lasers L from the laser radiating sections 1300′, and discharge of the supporting layer forming material from the supporting-layer-forming-material discharging sections 1730′ can also be performed in the same manner as explained above. The molten layers 310 and the supporting layers 300 can be formed in the same manner. Layers (molten layers 312 and the supporting layers 302) formed using the constituent-material discharging sections 1230′ and the supporting-layer-forming-material discharging sections 1730′ are thicker than layers (molten layers 311 and the supporting layers 301) formed using the constituent-material discharging sections 1230 and the supporting-layer-forming-material discharging sections 1730 (see FIGS. 9A to 9N).

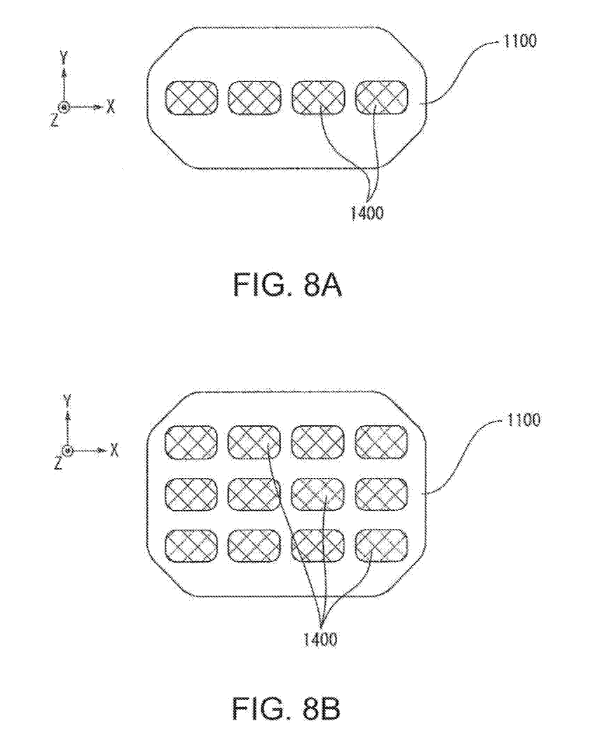

The number and the array of the head units 1400, 1400′, 1900, and 1900′ included in the forming apparatus 2000 according to this embodiment are not limited to the number and the array explained above. In FIGS. 8A and 8B, as examples of the number and the disposition, examples of other kinds of disposition of the head units 1400 disposed on the head base 1100 are schematically shown.

FIG. 8A shows a form in which the plurality of head units 1400 are arrayed in parallel in the X-axis direction on the head base 1100. FIG. 8B shows a form in which the head units 1400 are arrayed in a lattice shape on the head base 1100. Note that, in both the figures, the number of arrayed head units is not limited to the examples shown in the figure.

An example of a manufacturing method for a three-dimensional formed object performed using the forming apparatus 2000 according to this embodiment is explained.

FIGS. 9A to 9N are schematic diagrams showing an example of a manufacturing process for a three-dimensional formed object performed using the forming apparatus 2000. FIGS. 9A to 9N show an example of a manufacturing process in forming a complete body O of a three-dimensional formed object having a shape shown in FIG. 9N.

First, from a state shown in FIG. 9A, as shown in FIG. 9B, the supporting layer forming material is discharged from the supporting-layer-forming-material discharging sections 1730 to form the supporting layers 300 (301) in a first layer having small layer thickness. The supporting layers 300 (301) are formed in regions other than a formation region of a three-dimensional formed object (a region corresponding to the molten layer 310) in the first layer.

Subsequently, as shown in FIG. 9C, the supporting layer forming material is discharged from the supporting-layer-forming-material discharging sections 1730 to form the supporting layers 300 (301) in a second layer having small layer thickness.

Subsequently, as shown in FIG. 9D, the constituent material is discharged from the constituent-material discharging sections 1230 and the lasers L are radiated from the laser radiating sections 1300 to form the molten layers 310 (311) in portions corresponding to a contour region of the three-dimensional formed object in the second layer having the small layer thickness.

Subsequently, as shown in FIG. 9E, the constituent material is discharged from the constituent-material discharging sections 1230′ and the lasers L are radiated from the laser radiating sections 1300′ to form, as a first layer having large layer thickness corresponding to the first layer and the second layer having the small layer thickness, the molten layers 310 (312) in portions including a contour region on the lower surface side of the three-dimensional formed object and corresponding to the inside of the three-dimensional formed object.

Note that, as shown in FIG. 9E, the molten layers 312 formed by discharging the constituent material from the constituent-material discharging sections 1230′ (the supporting layers 302 formed by discharging the supporting layer forming material from the supporting-layer-forming-material discharging sections 1730 explained below) have thickness twice as large as the thickness of the molten layers 311 formed by discharging the constituent material from the constituent-material discharging sections 1230 and the supporting layers 301 formed by discharging the supporting layer forming material from the supporting-layer-forming-material discharging sections 1730.

Subsequently, as shown in FIG. 9F, the supporting layer forming material is discharged from the supporting-layer-forming-material discharging sections 1730′ to form the supporting layers 300 (302) having large layer thickness. The supporting layers 300 (302) are also formed in the regions other than the formation region of the three-dimensional formed object (the region corresponding to the molten layer 310).

Subsequently, as shown in FIG. 9G, the constituent material is discharged from the constituent-material discharging sections 1230′ and the lasers L are radiated from the laser radiating sections 1300′ to form, as a layer having large layer thickness, the molten layers 310 (312) in portions including a contour region on the side surface side of the three-dimensional formed object and corresponding to the inside of the three-dimensional formed object.

Subsequently, as shown in FIGS. 9H and 9I, as in FIGS. 9F and 9G, the supporting layers 300 (302) and the molten layers 310 (312) having large layer thickness are formed.

Subsequently, as shown in FIGS. 9J and 9K, as in FIGS. 9C and 9D, the supporting layers 300 (301) and the molten layers 310 (311) having small layer thickness are formed.

Subsequently, as shown in FIG. 9L, as in FIG. 9B, the supporting layers 300 (301) having small layer thickness are formed. Thereafter, as shown in FIG. 9M, as in FIG. 9E, the molten layers 310 (312) having large layer thickness are formed in portions including a contour region on the upper surface side of the three-dimensional formed object and corresponding to the inside of the three-dimensional formed object.

In this way, the complete body O of the three-dimensional formed object is completed. Note that FIG. 9N shows a state in which the complete body O of the three-dimensional formed object is removed from the sample plate 121 and developed (the supporting layers 300 are removed from the complete body O of the three-dimensional formed object).

Note that, in this embodiment, when the layers are formed, the molten layers 310 are formed after the supporting layers 300 are formed. However, the supporting layers 300 may be formed after the molten layers 310 are formed.

As shown in FIG. 9M and the like, in this embodiment, when an undercut section (a portion convex in the XY plane direction with respect to a lower layer) is present, the supporting layers 300 are layers that function as supporting layers in a lower layer and are capable of supporting the undercut section (so-called support layers). However, the supporting layers are not limited to being such supporting layers. For example, the supporting layers may be a layer formed over the entire upper surface of the sample plate 121, that is, a layer (a so-called peeling layer) capable of supporting the molten layers 310 in the first layer. By providing such a peeling layer, it is possible to reduce (facilitate) post-processes involved in the removal of the completed object O of the three-dimensional formed object from the sample plate 121. Note that, in the lower layer, the material M may be sintered by radiating the laser beam L from the laser radiating sections.

An example (an example corresponding to FIGS. 9A to 9N) of a manufacturing method for a three-dimensional formed object performed using the forming apparatus 2000 is explained with reference to a flowchart.

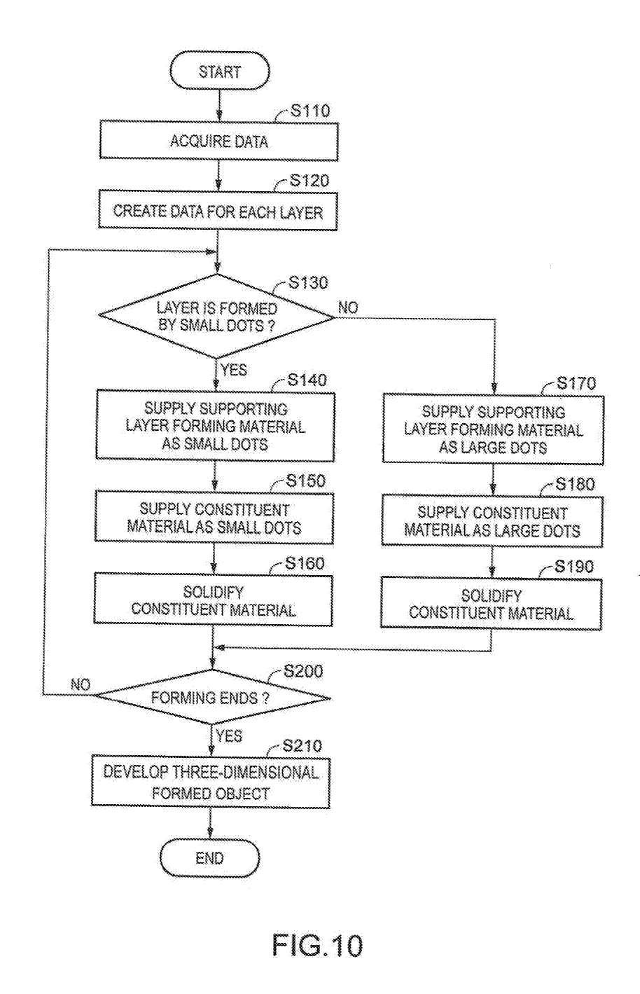

FIG. 10 is a flowchart of a manufacturing method for a three-dimensional formed object in this embodiment.

As shown in FIG. 10, in the manufacturing method for the three-dimensional formed object in this embodiment, first, in step S110, data of the three-dimensional formed object is acquired. Specifically, data representing the shape of the three-dimensional formed object is acquired from, for example, an application program executed in a personal computer.

Subsequently, in step S120, data for each layer is created. Specifically, in the data representing the shape of the three-dimensional formed object, the three-dimensional formed object is sliced according to forming resolution in the Z direction to generate bitmap data (sectional data) for each cross section.

The bitmap data generated in this case is data distinguished by a contour region of the three-dimensional formed object and a contact region of the three-dimensional formed object. Expressed in another way, the bitmap data is data in which a region formed by droplets (small dots) having a relatively small dot diameter discharged from the constituent-material discharging sections 1230 and the supporting-layer-forming-material discharging sections 1730 and a region configured by droplets (large dots) having a relatively large dot diameter discharged from the constituent-material discharging sections 1230′ and the supporting-layer-forming-material discharging sections 1730′ are formed to be distinguished for each layer.

Note that a difference between the sizes of the large dots and the small dots is not particularly limited. However, by setting the size of the large dots eight times or more as large as the size of the small dots, it is possible to particularly effectively and quickly manufacture a highly accurate three-dimensional formed object.

Subsequently, in step S130, it is determined whether a layer to be formed is a layer formed by the small dots or a layer formed by the large dots. Note that this determination is performed by a control section included in the control unit 400.

When it is determined in this step that the layer to be formed is the layer formed by the small dots, processing proceeds to step S140. When it is determined that the layer to be formed is the layer formed by the large dots, the processing proceeds to step S170.

In step S140, for example, as shown in FIGS. 9B and 9C, the supporting layer forming material is supplied as the small dots by discharging the supporting layer forming material from the supporting-layer-forming-material discharging sections 1730.

Subsequently, in step S150, for example, as shown in FIG. 9D, the constituent material is supplied as the small dots by discharging the constituent material from the constituent-material discharging sections 1230. Instep S160, the lasers L are radiated on the constituent material supplied in step S150 from the laser radiating sections 1300 to solidify the constituent material.

Note that steps S140, S150, and S160 are repeated a plurality of times in some case and are omitted in other cases depending on data.

Among steps S140, S150, and S160, in this embodiment, step S140 is performed first. However, step S150 and step S160 may be performed first.

On the other hand, in step S170, for example, as shown in FIG. 9F, the supporting layer forming material is supplied as the large dots by discharging the supporting layer forming material from the supporting-layer-forming-material discharging sections 1730′.

Subsequently, in step S180, for example, as shown in FIG. 9G, the constituent material is supplied as the large dots by discharging the constituent material from the constituent-material discharging sections 1230′. In step S190, the lasers L are radiated on the constituent material supplied in step S180 from the laser radiating sections 1300′ to solidify the constituent material.

Note that steps S170, S180, and S190 are repeated a plurality of times in some case and are omitted in other cases depending on data.

Among steps S170, S180, and S190, in this embodiment, step S170 is performed first. However, step S180 and step S190 may be performed first.

Steps S130 to S200 are repeated until forming of the three-dimensional formed object based on the bitmap data corresponding to the layers generated in step S120 ends instep S200.

When steps S130 to S200 are repeated and the forming of the three-dimensional formed object ends, in step S210, development of the three-dimensional formed object is performed to end the manufacturing method for the three-dimensional formed object in this embodiment.

As explained above, the manufacturing method for the three-dimensional formed object in this embodiment includes a layer forming step (steps S140 to S190) for discharging the flowable composition including particles (the paste-like constituent material containing metal particles) from the discharging sections (the constituent-material discharging sections 1230 and 1230′) in the state of droplets to form layers . The layer forming step includes a contour-layer forming step (step S150) for forming a contour layer (the molten layer 311) corresponding to the contour of the three-dimensional formed object and an internal-layer forming step (step S180) for forming an internal layer (the melded layer 312) corresponding to the inside of the three-dimensional formed object in contact with the contour layer. At least a part of the droplets (the small dots) in forming the contour layer in the contour-layer forming step is smaller than the droplets (the large dots) in forming the internal layers in the internal-layer forming step.

That is, in the manufacturing method for the three-dimensional formed object in this embodiment, the internal layer is formed by the relatively large droplets and the contour layer is formed by the relatively small droplets. Therefore, it is possible to quickly form the internal layer that does not need to be highly accurately formed in the three-dimensional formed object and it is possible to highly accurately form the contour layer that needs to be highly accurately formed in the three-dimensional formed object. Therefore, it is possible to quickly manufacture a highly accurate three-dimensional formed object.

Expressed in another way, the forming apparatus 2000 according to this embodiment includes the discharging sections (the constituent-material discharging sections 1230 and 1230′) that discharge, in a state of droplets, a flowable composition including particles and the control section included in the control unit 400 that controls the discharging sections to discharge the droplets to form layers. The control section performs control to form a contour layer corresponding to the contour of the three-dimensional formed object and an internal layer corresponding to the inside of the three-dimensional formed object in contact with the contour layer such that the droplets in forming the contour layer are smaller than at least a part of the droplets in forming the internal layer.

That is, the forming apparatus 2000 according to this embodiment forms the internal layer with the relatively large droplets and forms the contour layer with the relatively small droplets. Therefore, it is possible to quickly form the internal layer that does not need to be highly accurately formed in the three-dimensional formed object and it is possible to highly accurately form the contour layer that needs to be highly accurately formed in the three-dimensional formed object. Therefore, it is possible to quickly manufacture a highly accurate three-dimensional formed object.

The manufacturing method for the three-dimensional formed object in this embodiment can be expressed as being executed using, as the discharging sections, the first discharging section (the constituent-material discharging section 1230) and the second discharging section (the constituent-material discharging section 1230′) that discharge the droplets having the different sizes. Therefore, it is possible to easily discharge the relatively large droplets and the relatively small droplets.

Note that the “discharge the droplets having different sizes” not only means that both of the first discharging section and the second discharging section are capable of discharging the droplets having one kind of sizes and the sizes of the respective droplets are different but also means that, for example, at least one of the first discharging section and the second discharging section is capable of discharging the droplets having a plurality of kinds of sizes (for example, the first discharging section is capable of discharging droplets of 50 pl, 100 pl, and 150 pl and the second discharging section is capable of discharging droplets of 50 pl, 150 pl, and 300 pl) and the sizes of the droplets dischargeable from the first discharging section and the second discharging section are partially the same (for example, 50 pl).

Note that a correspondence relation between the constituent-material discharging section 1230 and the constituent-material discharging section 1230′ and the first discharging section and the second discharging section may be opposite.

The manufacturing method for the three-dimensional formed object in this embodiment includes a stacking step for repeating the layer forming step in the stacking direction as represented by the repetition of FIGS. 9A to 9N and steps S130 to S200. Therefore, it is possible to easily manufacture the three-dimensional formed object by stacking layers.

The layer forming step of the manufacturing method for the three-dimensional formed object in this embodiment includes a binding step for binding particles equivalent to steps S160 and S190. Therefore, it is possible to manufacture a robust three-dimensional formed object.

Note that examples of the “binding the particles” include, for example, sintering the particles or melting the particles as in this embodiment. Further, thermosetting resin, photosetting resin, or the like maybe contained in the flowable composition (the constituent material) including the particles. The particles maybe bound by hardening the resin.

In the layer forming step of the manufacturing method for the three-dimensional formed object in this embodiment, as shown in FIGS. 9B to 9E, it is possible to form a plurality of layers having small layer thickness (the melting layers 311 and the supporting layers 301) and thereafter form the molten layers 312 having large layer thickness in regions corresponding to the plurality of layers and melt (bind) the molten layers 312. Further, depending on the shape of a three-dimensional formed object to be formed, it is possible to form a plurality of molten layers 311 (and the supporting layers 301) having small layer thickness equivalent to the contour-layer forming step and thereafter form, in regions corresponding to the plurality of layers, the molten layers 312 having large layer thickness equivalent to the internal-layer forming step and bind the molten layers 312.

Expressed in another way, in the layer forming step of the manufacturing method for the three-dimensional formed object in this embodiment, it is possible to execute the contour-layer forming step a plurality of times to form a plurality of the contour layers, execute the internal-layer forming step to form internal layers corresponding to the thickness of the plurality of contour layers in regions corresponding to the plurality of contour layers, and execute the binding step to bind particles corresponding to the plurality of contour layers. By adopting such steps, it is possible to reduce the number of times of the internal-layer forming step. Therefore, it is possible to particularly quickly manufacture a highly accurate three-dimensional formed object.

In the forming apparatus 2000 according to this embodiment, it is possible to cause all of the constituent-material storing sections 1210a and 1210a′ to store the same constituent material and execute the manufacturing of the three-dimensional formed object. That is, in the layer forming step of the manufacturing method for the three-dimensional formed object in this embodiment, it is possible to discharge the flowable composition to the contour layer and the internal layer. Consequently, it is possible to manufacture the three-dimensional formed object with uniform components. It is possible to make use of material characteristics.

As shown in FIGS. 9A to 9N, in the forming apparatus 2000 according to this embodiment, the dot diameter of the droplets is adjusted such that the layers (the molten layers 312) formed by discharging the constituent material from the constituent-material discharging sections 1230′ and the layers (the supporting layers 302) formed by discharging the supporting layer forming material from the supporting-layer-forming-material discharging sections 1730′ have thickness twice as large as the thickness of the layers (the molten layers 311) formed by discharging the constituent material from the constituent-material discharging sections 1230 and the layers (the supporting layers 301) formed by discharging the supporting layer forming material from the supporting-layer-forming-material discharging sections 1730.

Therefore, for example, when the three-dimensional formed object to be formed includes a portion formed by overlaying a plurality (two) of the molten layers 311 having small layer thickness, the thickness of the portion formed by overlaying the plurality of layer (the two layers) of the molten layers 311 having small layer thickness is the thickness of one layer of the molten layer 312 having large layer thickness.

Expressed in another way, in the layer forming step of the manufacturing method for the three-dimensional formed object in this embodiment, the internal layers (the molten layers 312) having predetermined thickness are formed without overlaying droplets in the internal-layer forming step. The contour layers (the molten layers 311) having the predetermined thickness are formed by overlaying a plurality of droplets in the contour-layer forming step. That is, the layer thickness of the plurality contour layers (molten layers 311) corresponds to the layer thickness of one layer of the internal layer (the molten layer 312). Therefore, it is unnecessary to perform, for example, adjustment of layer thicknesses involved in the difference between the layer thicknesses of the contour layers and the internal layers. It is possible to easily manufacture a highly accurate three-dimensional formed object.

Note that “the contour layers having the predetermined thickness are formed by overlaying a plurality of droplets in the contour-layer forming step” not only means that the plurality of droplets are overlaid to form the contour layer having the predetermined thickness in one time of the contour-layer forming step but also means that the plurality of droplets are overlaid to form the contour layer having the predetermined thickness in a plurality of times of the contour-layer forming step.

The particles included in the constituent material are metal particle, ceramics particles, resin particles, or the like and are not particularly limited. However, the particles are desirably metal particles or alloy particles. This is because post-machining processes such as surface polishing are greatly reduced and it is possible to manufacture a highly accurate three-dimensional formed object.

The invention is not limited to the embodiment explained above and can be realized in various configurations without departing from the spirit of the invention. For example, the technical features in the embodiment corresponding to the technical features in the aspects described in the summary can be replaced or combined as appropriate in order to solve a part or all of the problems or achieve a part or all of the effects. Unless the technical features are explained in this specification as essential technical features, the technical features can be deleted as appropriate.

The entire disclosure of Japanese patent No. 2015-203459, filed Oct. 15, 2015 is expressly incorporated by reference herein.

What is claimed is:

1. A manufacturing method for a three-dimensional formed object comprising discharging a flowable composition including particles from a discharging section in a state of droplets and forming a layer, wherein
the forming the layer includes:
forming a contour layer corresponding to a contour of the three-dimensional formed object; and
forming an internal layer corresponding to an inside of the three-dimensional formed object in contact with the contour layer, and
at least a part of the droplets in the forming the contour layer is smaller than the droplets in the forming the internal layer.

2. The manufacturing method for the three-dimensional formed object according to claim 1, wherein the forming the layer is executed using, as the discharging section, a first discharging section and a second discharging section that discharge the droplets having different sizes.

3. The manufacturing method for the three-dimensional formed object according to claim 1, further comprising repeating the forming the layer in a stacking direction.

4. The manufacturing method for the three-dimensional formed object according to claim 1, wherein the forming the layer includes binding the particles.

5. The manufacturing method for the three-dimensional formed object according to claim 4, wherein
the forming the layer includes:
executing the forming the contour layer a plurality of times to form a plurality the contour layers;
executing the forming the internal layer to form the internal layer corresponding to thickness of the plurality of contour layers; and
executing the binding the particles to bind the particles.

6. The manufacturing method for the three-dimensional formed object according to claim 1, wherein the forming the layer includes discharging a flowable composition including same particles to the contour layer and the internal layer.

7. The manufacturing method for the three-dimensional formed object according to claim 1, wherein the forming the layer includes forming the internal layer having predetermined thickness without overlaying the droplets in the forming the internal layer and forming the contour layer having the predetermined thickness by overlaying a plurality of the droplets in the forming the contour layer.

8. The manufacturing method for the three-dimensional formed object according to claim 1, wherein the particles contain at least one of magnesium, iron, copper, cobalt, titanium, chrome, nickel, aluminum, maraging steel, stainless steel, cobalt chrome molybdenum, a titanium alloy, a nickel alloy, an aluminum alloy, a cobalt alloy, a cobalt chrome alloy, alumina, and silica.

9. A manufacturing apparatus for a three-dimensional formed object comprising:
a discharging section configured to discharge, in a state of droplets, a flowable composition including particles; and
a control section configured to control the discharging section to discharge the droplets to form layers, wherein
the control section performs control to form a contour layer corresponding to a contour of the three-dimensional formed object and an internal layer corresponding to an inside of the three-dimensional formed object in contact with the contour layer such that the droplets in forming the contour layer are smaller than at least a part of the droplets informing the internal layer.
